(19) United States
(12) Patent Application Publication
(10) Pub. No.: US 2025/0330930 A1
(43) Pub. Date: Oct. 23, 2025

(54) SYSTEM AND METHOD FOR SYNCHRONIZATION SEQUENCE BLOCK POWER AND BEAMFORMING OFFSET SIGNALING

(71) Applicant: Huawei Technologies Co., Ltd., Shenzhen (CN)

(72) Inventors: Mohammadhadi Baligh, Ottawa (CA); Haoyuan Wei, Stittsville (CA); Mostafa Medra, Ottawa (CA)

(21) Appl. No.: 19/237,696

(22) Filed: Jun. 13, 2025

Related U.S. Application Data
(63) Continuation of application No. PCT/CN2022/139164, filed on Dec. 15, 2022.

(51) Int. Cl. H04W 56/00; H04B 7/06

(52) U.S. Cl. CPC H04W 56/0015; H04B 7/06968

(57) ABSTRACT

Signaling is used to indicate to a UE the transmit power and/or beamforming information for each of one or more sets of SSB beams. The beamforming information may indicate an SSB-beam specific beamforming offset, also referred to herein as a power control offset. The signaling may alternatively indicate a value that combines transmit power and power control offset for each of one or more SSB beams. For example, now that the UE has the SSB-beam specific beamforming gain offset or EIRP offset, the UE may calculate the correct PL and select the SSB providing the least PL. Also, the signaled information can be used for uplink power control. The SSB set-specific information can be used for SSB selection, random access channel (RACH) transmission occasion selection; RACH power control, PUCCH power control; PUSCH power control; or beamforming and refinement at the UE.

### CROSS REFERENCE

The application is a continuation of International Application No. PCT/CN2022/139164, filed on Dec. 15, 2022, the disclosure of which is hereby incorporated by reference in its entirety.

### TECHNICAL FIELD

The application relates to wireless communications generally, and more specifically to transmission and reception of synchronization sequence blocks (SSB).

### BACKGROUND

An SSB is a block used for synchronization in time and frequency and provides an entry point decoding system information. System information is broadcast using a master information block (MIB) and a series of system information blocks (SIB), including SIB1 among others. The MIB is included in the SSB and contains essential information for a user equipment (UE) to decode SIB1 and the other SIBs. SIB1 contains system information allowing the UE to connect to a cell. The system information is transmitted in sequence with MIB transmitted first, followed by SIB1, then SIB2 etc.

Equivalent isotropic radiation power (EIRP) is the power radiated by a transmitter as if it has isotropic antennas and is based on the transmitted power plus antenna gain in the dB domain. Radio resource control (RRC) signaling is the higher layer control signaling which sets control plane information.

Multiple input multiple output (MIMO) systems at higher frequency bands such as mmwave frequencies tend to have many antennas at both the transmitter and receiver sides. In Long Term Evolution (LTE) and New Radio (NR), SSBs are introduced to help UEs perform initial access by detecting the cell, synchronize with the base station (BS) in both time and frequency dimensions and detect the MIB containing essential information which allows the UE camp on to the cell. With more and more antennas, more and more beamformed SSB transmissions in different directions are required in order to achieve coverage in all directions and depths within the desired cell coverage area. NR allows for up to 64 SSB transmissions on different directions on respective beams in a synchronization sequence (SS) burst. Abeam used to transmit a given SSB is referred to herein as an SSB beam. The number of antenna elements in the BS is expected to grow above 64 and hence SSB beams tend to be wider than the narrowest possible beams. Given that the SS burst overhead reduces the useful resources for communication, it is desirable not to have too many SSB in one SS burst. Moreover, a transmission of an SSB is narrow band with low payload overhead in MIB. With power concentration over the SSB, the required SSB coverage can be satisfied even with a relatively wider SSB beam alleviating the need for a very narrow SSB beam. While the SSBs generally contain the same information, they are distinguishable from each other, for example through primary broadcast channel (PBCH) demodulation reference signal (DMRS) sequence and PBCH payload.

In conventional systems, the UE searches for all the possible SSBs in a burst for a cell and selects the SSB with the highest reference signal received power (RSRP). In so doing, the UE treats the highest RSRP as an indication of the lowest path loss (PL) experienced by that SSB as among the possible SSBs, caused by favourable beam direction for that SSB beam. Using the selected SSB, the UE performs random access channel (RACH) communication to connect to the cell. The underlying assumption for selection of the SSB with the highest RSRP is that there is equal EIRP for each beam at the centre of its direction, resulting from equal transmit power and equal beamforming gain (equal beamwidth) for all the SSBs.

In NR, there is a signaling associated with SSB in “ServingCellConfigCommon” where an element is named “ss-PBCH-BlockPower” which defines the power of SSB. The ServingCellConfigCommon is part of SIB1 which is periodically transmitted by the BS. It can also be included in the RRC signaling to define a secondary cell (SCell). The purpose of ss-PBCH-BlockPower is for the UE to estimate the PL in the DL direction to be used in the UL direction. In order to compensate for the generally wider beam used for SSB transmission compared to beams used in UL communication, another parameter named powerControlOffsetSS is communicated to the UE. To estimate UL pathloss based on a received SSB, the pathloss estimate in the UL direction is based on the estimate of the PL in the downlink direction in combination with the powerControlOFFsetSS. In addition, in rel-16 of NR, ss-PBCH-BlockPower-r16 is defined in SSB-infoNcell-r16 which is used to signal to the UE in order to perform a measurement of a specific SSB of a specific neighbour cell.

### SUMMARY

Signaling is used to indicate to a UE the transmit power and/or beamforming information for each of one or more sets of SSB beams. The beamforming information may for example, indicate an SSB-beam specific beamforming offset, also referred to herein as a power control offset. The signaling may alternatively indicate a value that combines transmit power and power control offset for each of one or more SSB beams. This signaled information can then be used by the UE to select the best SSB and to allow for a more effective UL power control. For example, now that the UE has the SSB-beam specific beamforming gain offset or EIRP offset, the UE may calculate the correct PL and select the SSB providing the least PL. Also, or alternatively, the signaled information can be used for uplink power control, to find the PL to be in a power control formula. The SSB set-specific information can be used for SSB selection, random access channel (RACH) transmission occasion selection; RACH power control, PUCCH power control; PUSCH power control; Sounding Reference Signal (SRS) power control; or beamforming and refinement at the UE.

According to one aspect of the present disclosure, there is provided a method in a network device, the method comprising: transmitting signaling comprising, for each of at least one synchronization sequence block (SSB) set, SSB set-specific information for a respective set of beams used to transmit the SSB set, the SSB set-specific information comprising one or more of: an SSB set-specific indication of SSB power; an SSB set-specific indication of beamforming offset; or an SSB set-specific indication of a combination of SSB power and beamforming offset; for each of the at least one SSB set, transmitting the SSB set on the respective set of beams; wherein for each SSB set, the SSB set contains at least one SSB and the respective set of beams contains a respective beam for each SSB in the SSB set.

In some embodiments, each SSB set contains a single SSB.

In some embodiments, the single SSB is implicitly associated with a particular SSB through quasi co-location correspondence.

In some embodiments, each SSB set contains at least two SSB.

In some embodiments, the SSB set-specific indication of SSB power is an indication of absolute power.

In some embodiments, the SSB set-specific indication of SSB power is an indication of power relative to a baseline value.

In some embodiments, the SSB set-specific indication of an SSB beamforming offset is an indication of absolute power control offset.

In some embodiments, the SSB set-specific indication of an SSB beamforming offset is an indication of SSB beamforming offset relative to a baseline value.

In some embodiments, the SSB set-specific indication of a combination of SSB power and beamforming offset is an absolute indication of the combination.

In some embodiments, the SSB set-specific indication of the combination is a relative indication of the combination relative to a baseline value for the combination.

In some embodiments, the transmitting signaling comprising SSB set-specific information comprises transmitting the SSB set-specific information as part of a master information block (MIB) or a system information block (SIB).

In some embodiments, transmitting the SSB set-specific information as part of a master information block (MIB) or a system information block (SIB) comprises transmitting the SSB set-specific information in ServingCellConfigCommonSIB.

In some embodiments, the transmitting signaling comprising SSB set-specific information comprises transmitting the SSB set-specific information as part of signaling for RRC connection.

In some embodiments, the transmitting signaling comprising SSB set-specific information comprises transmitting the SSB set-specific information as part of RRC signaling after initial access is complete.

In some embodiments, the SSB set-specific information comprises respective SSB set-specific information for each of a plurality of synchronization sequence (SS) burst groups.

In some embodiments, the SSB set-specific information comprises respective SSB set-specific information for each of a plurality of SSB sets, wherein each set includes one SSB from each of a plurality of synchronization sequence (SS) burst groups.

In some embodiments, the SSB set-specific information comprises a set of indices each associated with a respective SSB, and SSB set-specific information, wherein the SSB set-specific information is applicable to each SSB having an index included in the set of indices and default information is applicable to each SSB having an index that is not included in the set of indices.

In some embodiments, the SSB set-specific information is signaled for a specific SSB on an as needed basis.

In some embodiments, the method further comprises: transmitting signaling comprising, for each of at least one SSB set transmitted by a neighbor cell, SSB set-specific information for a respective set of beams used to transmit the SSB set

According to another aspect of the present disclosure, there is provided a network device comprising: a processor and memory, the network device configured to execute the method as described herein.

According to another aspect of the present disclosure, there is provided a method in an apparatus, the method comprising: receiving signaling comprising, for each of at least one synchronization sequence block (SSB) set, SSB set-specific information for a respective set of beams used to transmit the SSB set, the SSB set-specific information comprising one or more of: an SSB set-specific indication of SSB power; an SSB set-specific indication of beamforming offset; or an SSB set-specific indication of a combination of SSB power and beamforming offset; for each of the at least one SSB set, receiving the SSB set on the respective set of beams; wherein for each SSB set, the SSB set contains at least one SSB and the respective set of beams contains a respective beam for each SSB in the SSB set.

In some embodiments, each SSB set contains a single SSB.

In some embodiments, the single SSB is implicitly associated with a particular SSB through quasi co-location correspondence.

In some embodiments, each SSB set contains at least two SSB.

In some embodiments, the SSB set-specific indication of SSB power is an indication of absolute power.

In some embodiments, the SSB set-specific indication of SSB power is an indication of power relative to a baseline value.

In some embodiments, the SSB set-specific indication of an SSB beamforming offset is an indication of absolute power control offset.

In some embodiments, the SSB set-specific indication of an SSB beamforming offset is an indication of SSB beamforming offset relative to a baseline value.

In some embodiments, the SSB set-specific indication of a combination of SSB power and beamforming offset is an absolute indication of the combination.

In some embodiments, the SSB set-specific indication of the combination is a relative indication of the combination relative to a baseline value for the combination.

In some embodiments, the receiving signaling comprising SSB set-specific information comprises receiving the SSB set-specific information as part of a master information block (MIB) or a system information block (SIB).

In some embodiments, receiving the SSB set-specific information as part of a master information block (MIB) or a system information block (SIB) comprises receiving the SSB set-specific information in ServingCellConfigCommonSIB.

In some embodiments, the receiving signaling comprising SSB set-specific information comprises receiving the SSB set-specific information as part of signaling for RRC connection.

In some embodiments, the receiving signaling comprising SSB set-specific information comprises receiving the SSB set-specific information as part of RRC signaling after initial access is complete.

In some embodiments, the SSB set-specific information comprises respective SSB set-specific information for each of a plurality of synchronization sequence (SS) burst groups.

In some embodiments, the SSB set-specific information comprises respective SSB set-specific information for each of a plurality of SSB sets, wherein each set includes one SSB from each of a plurality of synchronization sequence (SS) burst groups.

In some embodiments, the SSB set-specific information comprises a set of indices each associated with a respective SSB, and SSB set-specific information, wherein the SSB set-specific information is applicable to each SSB having an index included in the set of indices and default information is applicable to each SSB having an index that is not included in the set of indices.

In some embodiments, the SSB set-specific information is signaled for a specific SSB on an as needed basis.

In some embodiments, the method further comprises: receiving signaling comprising, for each of at least one SSB set transmitted by a neighbor cell, SSB set-specific information for a respective set of beams used to transmit the SSB set.

In some embodiments, the method further comprises using the SSB set-specific information for at least one of: SSB selection; random access channel (RACH) transmission occasion selection; RACH power control, PUCCH power control; PUSCH power control; or beamforming and refinement at the UE.

According to another aspect of the present disclosure, there is provided an apparatus comprising: a processor and memory, the apparatus configured to execute the method as described herein.

According to another aspect of the present disclosure, there is provided a computer readable medium having computer executable instructions stored thereon for causing a processor to perform the method as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 shows an example of SSB beams in differing horizontal and vertical directions;

FIG. 6 shows an example good transmit directions for a specific site;

FIG. 7 shows an example of SSB beam design for the example of FIG. 6; and

FIGS. 8 and 9 are flowcharts of methods of signaling SSB set-specific information.

### DETAILED DESCRIPTION

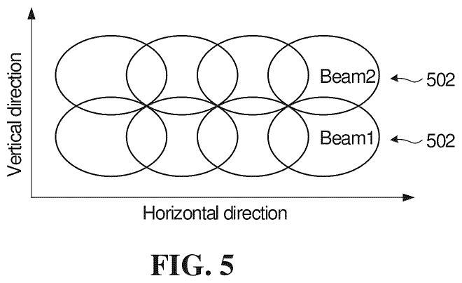

With large order MIMO, different SSB in a burst are transmitted over different directions to cover users in different distances and locations in the cell coverage area. This action is often called beam sweeping and the purpose is to ensure all the intended coverage area is served. The beamforming gain of the beam used for each SSB is inversely proportional to the solid angle covered by that beam. In many scenarios, the beams cover different areas in different directions. For example, FIG. 5 shows an example where SSBs are transmitted using eight different beams, including four different directions in the azimuth (horizontal) directions and two elevation (vertical) directions.

Although the beam footprints in the two-dimensional representation of FIG. 5 look the same, beams near zenith and nadir directions (e.g. beam 1500) occupy smaller solid angles with similar azimuth and elevation beam widths. As a result, beam 1500 has higher beamforming gain compared to beam 2 502. The array beamforming patterns are combined with the element beamforming pattern and hence the beam gain of beam 1 may be higher or lower depending on the panel antenna element design, and that can further impact the beam gain difference among different beams in both azimuth and elevation directions.

In the example of FIG. 5, beam 1 covers users that are closer to the BS and more likely to communicate using line of sight (LoS), experiencing better channel conditions, while beam 2 covers users that are relatively far from the BS and are more likely to communicate using non-line of sight (NLoS). Such users need more beamforming gain and/or transmit power to achieve the RSRP required to detect the SSB and decode the MIB. As such, beam 1 can be widened and/or transmitted with lower power compared to beam 2 to save overhead and power. Overall performance can be improved by using SSB beams with different beamforming gains, and by allocating different powers to the SSB beams, compared to transmitting SSBs with uniform power and beamforming gain.

The underlying assumption for selection of the SSB with the highest RSRP is that there is equal EIRP for each beam at the centre of its direction, resulting from equal transmit power and equal beamforming gain (equal beamwidth) for all the SSBs. However, when SSB beams are transmitted with different powers and beamforming gain, the aforementioned assumption will not hold well as both the power and beam shape and width among the SSBs can be different. In NR, there is no signaling to distinguish the power and beamforming gain amongst different SSBs in the SS burst. As such, using conventional methods, the SSB that is selected based solely on RSRP is not always the best.

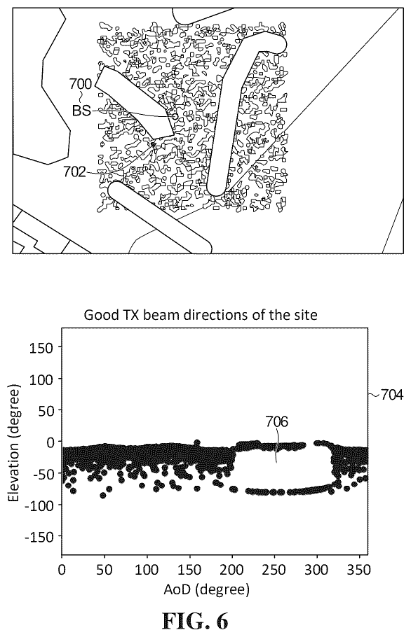

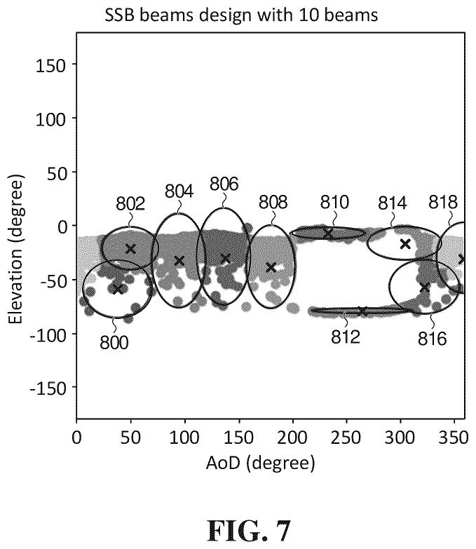

The problem of unbalanced beamforming gain and power allocation may be more pronounced when environment aware SSB optimization is used. For example, if a BS and UE located within the coverage area of the BS are shown in FIG. 6 which shows BS 700, many possible UE locations as dots, and a building 702 within the coverage area of the BS, possible beam directions are shown at 704. It can be seen that the location of the building 702 eliminates the utility of beam directions in a wide range of azimuth and elevation combinations. That region is represented by the wide white area 706 at Azimuth directions between 200 to 320 degrees and elevation direction between −15 to −80 degrees. An environment aware SSB beam design algorithm would avoid transmission of SSBs in the white area 706. An example of possible recommended SSB beam directions for this case is shown in FIG. 7 which shows 10 SSB beams 800, . . . , 818. In the example of FIG. 7, it can be seen that the designed beams have different shapes and widths in the azimuth and elevation directions covering unbalanced solid angles and while mostly cover azimuth directions or range (sweeping in azimuth), there is some level of coverage in elevation (elevation sweeping). The EIRP imbalance amongst beams for such a scenario can be even more drastic than would be the case for a set of beams with regular 2D sweeping, such as the beams shown in FIG. 5.

Such discrepancies between the beamforming gain and transmit power can impact the SSB selection behavior by UEs that are located in the coverage overlap of different SSBs or that can receive more than one SSB from different directions through different reflectors. In such cases, selecting the SSB with the best RSRP may lead to selecting a beam with higher overall PL caused by unequal EIRP among them.

After initial access, SSB beams can be used by UE as a reference signal to estimate PL for UL power control. However, after initial access, as the UE moves within the coverage area of the cell, the UE moves to be within the coverage area of different SSB beams, and should perform UL power control using different SSBs as its PL reference. Discrepancies between beamforming gain and transmit power result in a sudden jump in the evaluated PL when changing the PL reference from one SSB to another.

Furthermore, in some scenarios, the SSB is transmitted from different nodes in the same network (such as a micro BS and a macro BS) with different power budgets working in the same bandwidth under the umbrella of the same cell. In this case, a power imbalance is inevitable.

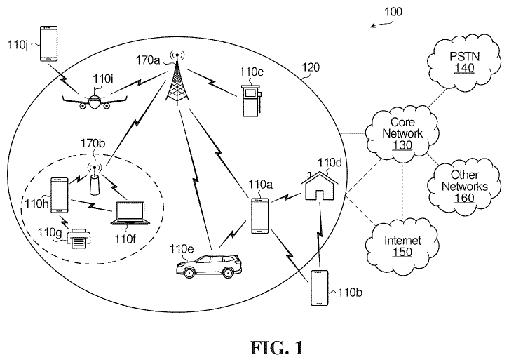

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

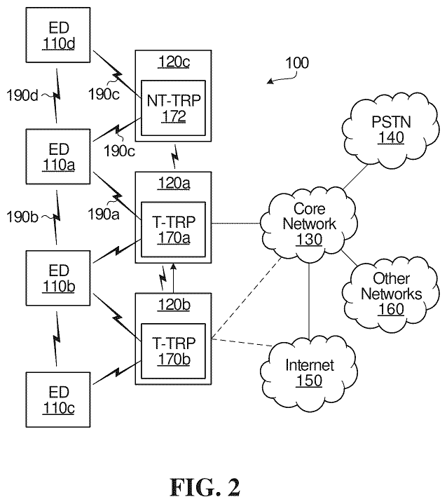

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing, and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED nod may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED nod and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some, or all, of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

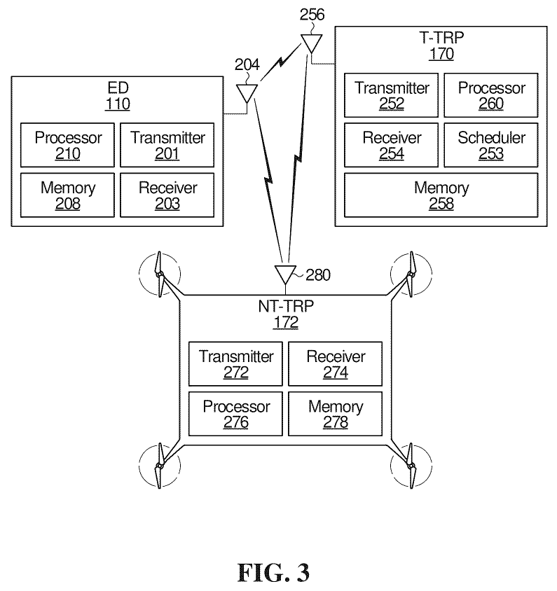

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

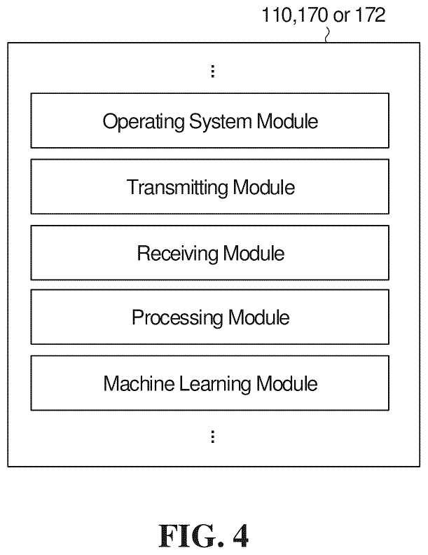

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

In accordance with embodiments of the application, signaling is used to indicate to a UE the transmit power and/or beamforming information for each of one or more SSB beams. The beamforming information may for example, indicate an SSB-beam specific beamforming offset, also referred to herein as a power control offset. The signaling may alternatively indicate a value that combines transmit power and power control offset for each of one or more SSB beams. This signaled information can then be used by the UE to select the best SSB and to allow for a more effective UL power control. For example, now that the UE has the SSB-beam specific beamforming gain offset or EIRP offset, the UE may calculate the correct PL and select the SSB providing the least PL. Also, or alternatively, the signaled information can be used for uplink power control, to find the PL to be in a power control formula.

Embodiments are described in detail below in which each indicated SSB power and/or power control offset is specific to an individual SSB. Other embodiments are described in which each indicated SSB power and/or power control offset is specific to a group of SSB, in which case, each SSB in the group of SSB has the indicated SSB power and power control offset. More generally, for any embodiment described herein, an indicated SSB power and/or power control offset can be set specific, to a set of SSB, each set of SSB containing one or more SSB. In this case, each SSB in a set has the indicated set-specific power and/or power control offset, and more generally has indicated SSB set-specific information. In some embodiments, every SSB set includes only one SSB, in which case, the set-specific embodiment relates to the embodiments where each indicated SSB power and/or power control offset (more generally SSB set-specific information) is specific to an individual SSB. In some embodiments, every SSB set includes only at least two SSB, in which case, the set-specific embodiment relates to the group specific embodiments, where each indicated SSB power and/power control offset (more generally SSB set-specific information) is specific to a group of SSB. Finally, in some embodiments, one or more SSB sets each include a single SSB, and one or more other SSB sets each include at least two SSBs.

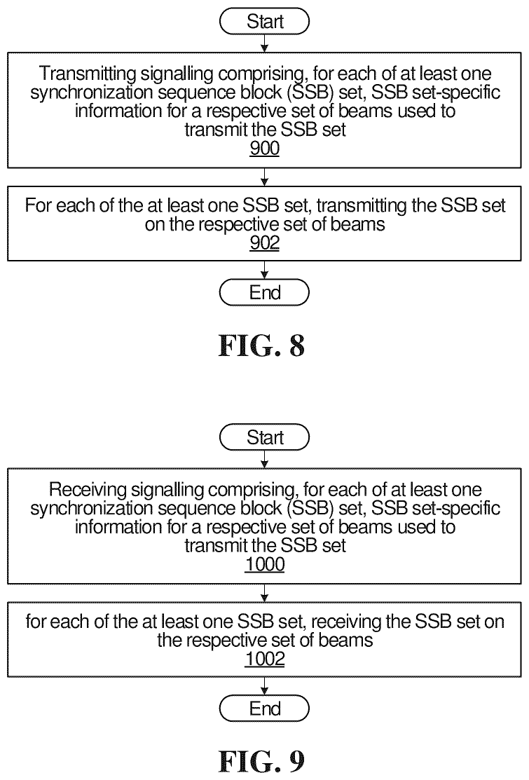

Flowcharts of two general methods will now be described with reference to FIGS. 8 and 9. It should be understood that these methods can be implemented in concert with any of the specific details included below. Referring now to FIG. 8, shown is a flowchart of a method of signaling, by a network device, SSB set-specific information provided by an embodiment of the application. The method begins in block 900 with a network device transmitting signaling comprising, for each of at least one synchronization sequence block (SSB) set, SSB set-specific information for a respective set of beams used to transmit the SSB set. The SSB set-specific information comprising one or more of:
an SSB set-specific indication of SSB power;
an SSB set-specific indication of beamforming offset; or
an SSB set-specific indication of a combination of SSB power and beamforming offset;
   The method continues in block 902 with, for each of the at least one SSB set, transmitting the SSB set on the respective set of beams. For each SSB set, the SSB set contains at least one SSB and the respective set of beams contains a respective beam for each SSB in the SSB set.

Referring now to FIG. 9, shown is a flowchart of a method of signaling, by an apparatus such as a UE, SSB set-specific information provided by an embodiment of the application. The method begins in block 1000 with an apparatus receiving signaling comprising, for each of at least one synchronization sequence block (SSB) set, SSB set-specific information for a respective set of beams used to transmit the SSB set. The SSB set-specific information comprising one or more of:
an SSB set-specific indication of SSB power;
an SSB set-specific indication of beamforming offset; or
an SSB set-specific indication of a combination of SSB power and beamforming offset;
   The method continues in block 1002 with, for each of the at least one SSB set, receiving the SSB set on the respective set of beams. For each SSB set, the SSB set contains at least one SSB and the respective set of beams contains a respective beam for each SSB in the SSB set.

With the new signaling, the UE is made aware of any mismatch among the SSBs in terms of power and beamforming. This information can be acquired at the time of initial access for the purpose of beam selection and power control for both initial access signaling such as RACH communication and other uplink channels or through other signaling for power control and non-initial access.

The information related to the SSB power can be relative or absolute. The information can be transmitted as part of a SIB or using RRC signaling. Detailed examples are described below.

In some embodiments, to convey an SSB-specific power, signaling of an indication of absolute power is used. For example, an information element (IE) value ss-PBCH-specific-BlockPower may be used. In this case, an indication of the SSB absolute power is signaled to the UE. That value supersedes any value signaled by IE ss-PBCH-BlockPower. The UE uses this value to find a PL for each SSB which in turn is used to select the best beam in terms of PL. and/or for to find a PL to use in UL power control.

Alternatively, in some embodiments, to convey SSB-specific power an indication of SSB power relative to a baseline value is used. For example, a relative IE value ss-PBCH-specific-BlockPower-offset may be used. In this case, the value signaled to the UE indicates the SSB-specific power relative to a baseline value, for example, as signaled by ss-PBCH-BlockPower. In that case, the SSB-specific power is ss-PBCH-specific-BlockPower-offset+ss-PBCH-BlockPower. Again, the UE uses this value to find a PL for each SSB which in turn is used to select the best beam in terms of PL and/or for to find a PL to use in UL power control.

In some embodiments, to convey an SSB-specific beamforming offset, signaling of an indication of absolute beamforming offset is used. For example, an absolute IE value ss-PBCH-specific-additional-powercontrol-offset can be signaled to the UE to convey SSB absolute beamforming offset. That value supersedes any value signaled by powerControlOffsetSS for the purpose of uplink power control. Moreover, the UE takes into account this value to update its PL estimate for different SSBs for the purpose of SSB selection.

In some embodiments, to convey an SSB-specific beamforming offset, signaling of an indication of beamforming offset relative to a baseline value is used. For example, a relative IE value ss-PBCH-specific-additional-powercontrol-offset can be signaled to the UE to convey the SSB beamforming offset with respect to a baseline powerControlOffsetSS. In that case, the pathloss offset for the purpose of uplink power control can be determined according to ss-PBCH-specific-additional-powercontrol-offset+powerControlOffsetSS. Similar to the above case, the UE takes into account this value to update its PL estimate for different SSBs for the purpose of SSB selection.

In some embodiments, signaling is used to convey an indication of a combination of an SSB power for a respective beam used to transmit the SSB and a beamformer power control offset for the respective beam.

For example, in some embodiments, the BS signals an indication of an absolute value of such a combination of values. For example, ss-PBCH-specific-effective-BlockPower may be transmitted which is a replacement for both ss-PBCH-specific-Block-Power-offset and ss-PBCH-specific-additional-powercontrol-offset essentially combining the two values into one.

For example, in some embodiments, the BS signals an indication of a value of the combination relative to a baseline value for the combination. For example, ss-PBCH-specific-effective-BlockPower-offset may be transmitted which is a replacement for both ss-PBCH-specific-BlockPower-offset and ss-PBCH-specific-Block-Power-extra-offset essentially combining the two values into one.

In some embodiments, the signaling is conveyed during initial access. Two examples include using MIB/SIBs, and using the signaling that is used for RRC connection. For initial access, the UE searches for periodically transmitted SSBs to identify the cell, to synchronize in time and frequency domains with the BS. The UE decodes the primary broadcast channel (PBCH) content (namely the MIB) and also decodes SIB including SIB1 to get access to the necessary information such as how to perform RACH Msgi transmission to access the cell. Part of that information is related to the common configuration of the cell and is referred to as ServingCellConfigCommonSIB. Among the information communicated in this message is ss-PBCH-BlockPower which is used in combination with powerControlOffsetSS, to determine the pathloss for the purpose of uplink power control. That information is common for all the SSBs. In this embodiment, one or more SSB-specific powers and/or beamforming offsets are communicated to the UE using signaling.

In the detailed examples below, it is assumed that the signaling conveys an indication of absolute value of the combination of SSB power and beamforming offset for a given SSB. However, similar signaling can be used to convey an indication of relative value of the combination, or similar signaling can be used to convey two values for SSB power and beamforming offset, or relative SSB power and relative beamforming offset.

In one embodiment, a specific value for the SSB-specific power value of a particular SSB is sent, such as this-ss-PBCH-effective-BlockPower. This value can be an integer, for example with the same range of ss-PBCH-BlockPower (−60 to +50), replacing the value in the ServingCellConfigCommonSIB if it is transmitted to the UE. Alternatively, the value can be selected from a table containing real valued power levels. This new value can be part of SIB1 as an optional field. In some embodiments, the value signaled in SIB1 is implicitly associated with a specific SSB through quasi co-location (QCL) correspondence between a beam used to transmit the SIB1 and a specific SSB. More specifically, if the beam used to transmit SIB1 has QCL correspondence with a specific SSB, then the SSB-specific value is associated only with the corresponding SSB. If such a field exists in SIB1 associated with any SSB, it takes precedent for that particular SSB over the aforementioned value common for all SSB. Alternatively, that field can be transmitted in other SIBs. The UE may use this information in various use cases that may include any or all of the following: SSB selection, RACH transmission occasion selection, RACH power control, PUCCH and PUSCH power control, and beamforming and refinement at the UE side.

More generally, this information can be sent on any sub-field(s) of SIB1 or any other SSB-specific SIB information field. However, the later the UE receives such information, the later the UE will be able to use the information. For example, if the UE receives this information after RACH transmission, it cannot be used for RACH occasion selection and power control.

In another embodiment, a set of specific values for different SSBs is transmitted, for example as part of ServingCellConfigCommonSIB. A few alternatives are described below.

In a first alternative, an array of SIB-power, for example, ss-PBCH-effective-BlockPower-array, which is an array of size 64 (in case of 64 SSBs) is sent. Each element of the array may be an integer having the same range of ss-PBCH-BlockPower. The UE associates each value in the array with a corresponding SSB in the burst. Alternatively, each element can be selected from a table containing real valued power levels.

In a second alternative, an array indicating a respective SIB-power per SS burst group is transmitted, a SS burst group being a subset of up to 64 possible SSBs. For example, an array ss-PBCH-effective-BlockPower-burstgroup-array may be transmitted, which is an array of size 8 (similar to the one defined for ssb-PositionsInBurst, more generally having a size large enough for the number of burst groups). Again, each element may be an integer having the same range of ss-PBCH-BlockPower. In this case, all the SSB inside a given SS burst use the respective value in the array. In other words, all the SSB in a first burst group use the first entry in the array, all the SSB in the second burst group use the second entry in the array and so on. Alternatively, each element can be selected from a table containing real valued power levels.

In another alternative, an array indicating a respective SIB-power per SSB within an SS burst group is transmitted. In this case, the first SSB in any of the SS bursts use the first value in the array, the second SSB in any burst use the second value and so on. In a specific example, an array ss-PBCH-effective-BlockPower-burstlocation-array containing such values is transmitted.

In a third alternative, an array is transmitted that identifies a set of SSBs with a different power. A value of ss-PBCH-effective-BlockPower-subset is transmitted which is an integer in the same range of ss-PBCH-BlockPower. Alternatively, the value can be selected from a table containing real valued power levels. This is associated with a list in the array that identifies SSBs (SSindex-for-block-power) in the burst having a special effective power, e.g. ss-PBCH-effective-BlockPower-subset. For a given SSB having an SSB index, the UE assumes the special effective power if the SSB index is included in the list, and uses the default value if the SSB index is not in the list. The list of SSB indicate one or more of the SSB.

It is noted that for any of the alternatives described above, the same information can be transmitted in a later SIB. However, again the later the UE receives the signaling, the later it can use it for beam selection and power control.

It is noted that for any of the alternatives described above, rather than using an absolute value, an offset compared to an already known base value can be transmitted. With this approach, the range of the integer can be substantially reduced for example to (−7 to 0) or (−4 to +3).

Alternatively, this signaling can be performed as part of an RRC connection procedure, such as in Msg2, Msg4 or MsgB in the RACH process. In this case, the information signaled cannot be used for RACH signaling itself but can be used for any future beam selection or PL estimation.

With the signaling mechanism discussed above, the UE remains aware of any mismatch among the SSB in terms of its allocated power and/or EIRP. Especially in the embodiment described above in which a specific value for the SSB-specific power value of a particular SSB is sent, the extra overhead is limited to the one or two extra integers/extra values that are included in a SIB message as optional. With such signaling, the correct values for SSB beamforming and uplink power control are used by the UE ensuring smooth transitioning between different beams of SSB.

In some embodiments, the UE is informed of the per-SSB power after initial access is complete, for example through RRC signaling. For example, after initial access, the UE receives ServingCellConfigCommon using RRC signaling indicating what the user needs to know about a secondary cell. The content of this message is similar to the SIB version of the ServingCellConfigCommon, but with more details. According to 38.331, “The IE contains parameters which a UE would typically acquire from SSB, MIB or SIBs when accessing the cell from IDLE. With this IE, the network provides this information in dedicated signaling when configuring a UE with a SCells or with an additional cell group (SCG). It also provides itfor SpCells (MCG and SCG) upon reconfiguration with sync.” (see 38.331 Radio Resource Control (RRC) protocol specification v17.2.0). In this case, the UE can know the per-SSB power for Scells and cell groups before trying to attach to them. The content of the new signaling can be similar to the second and third alternatives described above, but not the first alternative. In this case, the UE knows the power assignments for the new Scell before even detecting them.

Alternatively, or additionally, signaling of per-SSB power can be transmitted in respect of SSBs transmitted by a neighbour cell for the purpose of neighbour cell measurement. Such signaling can be attached to accompanying IEs such as SSB-Configuration-r16.

Similar to the above-described embodiment in which per-SSB power is signaled during initial access, the new signaling after initial access ensures the UE is knowledgeable about the SSB EIRP mismatch which can be incorporated into selecting the right SSB beam and a smooth UL power control. The power mismatch between different SSB is likely to stay for very long time. For example, different power is allocated to SSB due to environmental conditions, the environmental conditions may be constant for a long period of time. If a UE stays connected to a cell, the UE will only need to obtain the information once. Similarly, in embodiments where per-SSB power is transmitted on demand on an as needed basis (for example, transmission of a value for a secondary cell in RRC signaling), the transmission is infrequent, only when requested. For this reason, the overhead of this type of signaling is not high.

Numerous modifications and variations of the present disclosure are possible in light of the above teachings. It is therefore to be understood that within the scope of the appended claims, the disclosure may be practiced otherwise than as specifically described herein.

For example, the embodiments above have focused on multi-beam base stations, but more generally, the same approach is applicable to multi-TRP cells in the wireless systems, where power mismatch may happen between different SSBs as different entry point beams of the systems associated with different TRPs of the same cell with different peak transmit powers, different number of antennas and/or different capabilities. More generally still, the approach is applicable in any wireless access systems allowing for transmission of SSB on SSB beams with different power (i.e. power assignment). While this invention is written in a 3GPP specific manner, it can be applied to other access systems where beacon beam sweeping may be applied, SSB beams being a specific example of beacon beams.

1. A method in a network device, the method comprising:
transmitting signaling, the signaling comprising, for each synchronization sequence block (SSB) set of at least one SSB set, SSB set-specific information for a respective set of beams used to transmit each SSB set of the at least one SSB set, the SSB set-specific information comprising one or more of:
an SSB set-specific indication of SSB power,
an SSB set-specific indication of beamforming offset, or
an SSB set-specific indication of a combination of SSB power and beamforming offset; and
transmitting each SSB set of the at least one SSB set on the respective set of beams,
wherein each SSB set of the at least one SSB set contains at least one SSB, and the respective set of beams contains a respective beam for each SSB set of the at least one SSB set.

2. The method of claim 1, wherein each SSB set of the at least one SSB set contains a single SSB.

3. The method of claim 2, wherein the single SSB is implicitly associated with a particular SSB through quasi co-location correspondence.

4. The method of claim 1, wherein each SSB set of the at least one SSB set contains at least two SSB.

5. The method of claim 1, wherein the SSB set-specific indication of SSB power indicates absolute power.

6. A device comprising:
at least one processor; and
a memory, the device configured to perform operations including:
transmitting signaling, the signaling comprising, for each synchronization sequence block (SSB) set of at least one SSB set, SSB set-specific information for a respective set of beams used to transmit each SSB set of the at least one SSB set, the SSB set-specific information comprising one or more of:
an SSB set-specific indication of SSB power,
an SSB set-specific indication of beamforming offset, or
an SSB set-specific indication of a combination of SSB power and beamforming offset; and
transmitting each SSB set of the at least one SSB set on the respective set of beams,
wherein each SSB set of the at least one SSB set contains at least one SSB, and the respective set of beams contains a respective beam for each SSB set of the at least one SSB set.

7. The device of claim 6, wherein each SSB set of the at least one SSB set contains a single SSB.

8. The device of claim 7, wherein the single SSB is implicitly associated with a particular SSB through quasi co-location correspondence.

9. The device of claim 6, wherein each SSB set of the at least one SSB set contains at least two SSB.

10. The device of claim 6, wherein the SSB set-specific indication of SSB power indicates absolute power.

11. A method in an apparatus, the method comprising:
receiving signaling, the signaling comprising, for each synchronization sequence block (SSB) set of at least one SSB set, SSB set-specific information for a respective set of beams used to transmit each SSB set of the at least one SSB set, the SSB set-specific information comprising one or more of:
an SSB set-specific indication of SSB power,
an SSB set-specific indication of beamforming offset, or
an SSB set-specific indication of a combination of SSB power and beamforming offset; and
receiving each SSB set of the at least one SSB set on the respective set of beams,
wherein each SSB set of the at least one SSB set contains at least one SSB, and the respective set of beams contains a respective beam for each SSB set of the at least one SSB set.

12. The method of claim 11, wherein each SSB set of the at least one SSB set contains a single SSB.

13. The method of claim 12, wherein the single SSB is implicitly associated with a particular SSB through quasi co-location correspondence.

14. The method of claim 11, wherein each SSB set of the at least one SSB set contains at least two SSB.

15. The method of claim 11, wherein the SSB set-specific indication of SSB power indicates absolute power.

16. An apparatus comprising:
at least one processor; and
a memory, the apparatus configured to perform operations including:
receiving signaling, the signaling comprising, for each synchronization sequence block (SSB) set of at least one SSB set, SSB set-specific information for a respective set of beams used to transmit each SSB set of the at least one SSB set, the SSB set-specific information comprising one or more of:
an SSB set-specific indication of SSB power,
an SSB set-specific indication of beamforming offset, or
an SSB set-specific indication of a combination of SSB power and beamforming offset; and
receiving each SSB set of the at least one SSB set on the respective set of beams,
wherein each SSB set of the at least one SSB set contains at least one SSB, and the respective set of beams contains a respective beam for each SSB set of the at least one SSB set.

17. The apparatus of claim 16, wherein each SSB set of the at least one SSB set contains a single SSB.

18. The apparatus of claim 17, wherein the single SSB is implicitly associated with a particular SSB through quasi co-location correspondence.

19. The apparatus of claim 16, wherein each SSB set of the at least one SSB set contains at least two SSB.

20. The apparatus of claim 16, wherein the SSB set-specific indication of SSB power indicates absolute power.
